(19) United States
(12) Patent Application Publication
(10) Pub. No.: US 2025/0301431 A1
(43) Pub. Date: Sep. 25, 2025

(54) TRANSMISSION AND DECODING OF SYNCHRONIZATION SIGNAL DATA BLOCKS

(71) Applicant: Nokia Technologies Oy, Espoo (FI)

(72) Inventors: Alessio MARCONE, Munich (DE); Kari Juhani HOOLI, Oulu (FI)

(21) Appl. No.: 18/861,936

(22) PCT Filed: Apr. 21, 2023
(86) PCT No.: PCT/EP2023/060387

§ 371 Date: Oct. 31, 2024

(30) Foreign Application Priority Data
May 4, 2022 (GB) 2206470.3

(51) Int. Cl. H04W 56/00; H04L 1/00; H04W 72/044; H04W 72/30

(52) U.S. Cl. CPC H04W 56/0015; H04L 1/0068; H04W 72/044; H04W 72/30

(57) ABSTRACT

A method including providing data for transmission on a data channel of a synchronization signal block of a transmission frame; identifying a first portion of the data and a second portion of the data, wherein the second portion of the data repeats at least part of the first portion of the data. The data may be allocated to resource elements of the data channel according to a predetermined allocation scheme, wherein at least part of the first portion of the data is allocated to resource elements outside of a predetermined set and at least part of the second portion of the data is allocated to resource elements of the predetermined set. At least part of the one or more resource elements of the predetermined set may be punctured. A portion of the data on the data channel may be transmitted using available resource elements after the puncturing.

### FIELD

The present specification relates generally to the field of wireless communications. More specifically, some example embodiments may relate to the punctured transmission of synchronization signal block (SSB) data and some example embodiments may relate to the decoding of punctured SSB data.

### BACKGROUND

Wireless communication networks may transmit synchronization signal blocks to enable initial access to the network. In addition to synchronization signals, a synchronization signal block (SSB) may carry a data channel, such as for example a physical broadcast channel (PBCH). In some applications, it may be desired to operate the wireless communication system at a narrow bandwidth, for example narrower than the bandwidth for which the SSB was originally designed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising means for: providing data for transmission on a data channel of a synchronization signal block of a transmission frame; identifying a first portion of the data and a second portion of the data, wherein the second portion of the data repeats at least part of the first portion of the data; identifying a predetermined set of one or more resource elements of the data channel; allocating the data to resource elements of the data channel according to a predetermined allocation scheme, wherein at least part of the first portion of the data is allocated to resource elements outside of the predetermined set and at least part of the second portion of the data is allocated to resource elements of the predetermined set; puncturing at least part of the one or more resource elements of the predetermined set; and transmitting a portion of the data on the data channel using available resource elements for the synchronization signal block after the puncturing.

The predetermined set of one or more resource elements may be at at least one edge of the synchronization signal block.

The predetermined set of one or more resource elements may comprise two groups of resource elements at opposite edges of the synchronization block. Each of the two groups of resource elements may comprise four or less resource blocks per symbol.

The data channel may comprise a physical broadcast channel (PBCH). The predetermined set of one or more resource elements of the PBCH may comprise two groups of resource elements corresponding to symbol numbers 1, 2 and 3.

The predetermined set of one or more resource elements may not overlap in frequency with resource elements allocated to synchronization signal(s).

The data may comprise an ordered bit sequence and allocating the first portion of the data according to the predetermined allocation scheme may comprise: identifying one or more first sections of the ordered bit sequence that are within the first portion of the data and would map to resource elements of the predetermined set; identifying a corresponding number of second sections of the ordered bit sequence that correspond to the second portion of the data and which map to resource elements outside of the predetermined set; and moving ordered bits of the identified one or more first sections to replace ordered bits of respective second sections.

The apparatus may further comprise means for, as part of the moving operation, moving the replaced ordered bits of the respective second sections to replace the ordered bits of the identified one or more first sections.

The moving of the ordered bits of the identified one or more first sections may be performed by: determining an offset based at least in part on the bit length N of the first portion of the data sequence; and adding the offset to bit positions of the bits within each identified first section.

The bit sequence may be received from a rate matching buffer after a channel encoder.

The data may comprise an ordered bit sequence and allocating the first portion of the data may comprise mapping a sequence of symbols, generated based on modulating the provided data, to the resource elements of the data channel in increasing order of, firstly, time indices and, secondly, frequency indices, starting from a frequency index offset corresponding to a frequency index outside of the predetermined set.

The frequency index offset may correspond to the first frequency index outside of the predetermined set.

The punctured one or more resource elements may not be transmitted.

The apparatus may be configured to perform at least the puncturing responsive to detecting that a narrowband mode of operation is required.

The apparatus may be a base station of a radio access network or, alternatively, a user equipment or similar.

According to a second aspect, there is described an apparatus for: receiving, from a transmitting apparatus, a synchronization signal block of a transmission frame, wherein the synchronization signal block comprises a data channel; extracting data from resource elements of the data channel, wherein the extraction of the data from the resource elements is based on reversing at least part of a predetermined allocation scheme performed by the transmitting apparatus; and decoding the data.

The data channel may comprise a physical broadcast channel (PBCH).

The predetermined allocation scheme may comprise allocating a first portion of the data to resource elements outside of a predetermined set of resource elements which are to be all or partly punctured and at least a second portion of the data, which repeats at least part of the first portion of the data, to resource elements of the predetermined set of resource elements which are to be all or partly punctured.

The extracting of the data from the resource elements may be based on reversing at least the allocation of the first portion of the data to the resource elements outside of the predetermined set of resource elements and the allocation of the second portion of the data to the resource elements of the predetermined set of resource elements.

The predetermined allocation scheme may be a standardized allocation scheme or is determined based on receiving from the transmitting apparatus an indication of the predetermined set of resource elements which are to be all or partly punctured.

The apparatus may further comprise means for performing: determining that the transmitting apparatus has, or may have applied, the predetermined allocation scheme, wherein the extracting operation is performed responsive to the determination. The determining may be based on one or more of: a synchronization raster point in the received synchronization signal block being indicative that puncturing has been performed according to the predetermined allocation scheme; and a frequency band used for the received synchronization signal block indicative of narrowband operation.

The apparatus may comprise a user equipment (UE) or, alternatively, a base station or similar.

According to a third aspect, there is described a method, the method comprising: providing data for transmission on a data channel of a synchronization signal block of a transmission frame; identifying a first portion of the data and a second portion of the data, wherein the second portion of the data repeats at least part of the first portion of the data; identifying a predetermined set of one or more resource elements of the data channel; allocating the data to resource elements of the data channel according to a predetermined allocation scheme, wherein at least part of the first portion of the data is allocated to resource elements outside of the predetermined set and at least part of the second portion of the data is allocated to resource elements of the predetermined set; puncturing at least part of the one or more resource elements of the predetermined set; and transmitting a portion of the data on the data channel using available resource elements for the synchronization signal block after the puncturing.

The predetermined set of one or more resource elements may be at at least one edge of the synchronization signal block.

The predetermined set of one or more resource elements may comprise two groups of resource elements at opposite edges of the synchronization block. Each of the two groups of resource elements may comprise four or less resource blocks per symbol.

The data channel may comprise a physical broadcast channel (PBCH). The predetermined set of one or more resource elements of the PBCH may comprise two groups of resource elements corresponding to symbol numbers 1, 2 and 3.

The predetermined set of one or more resource elements may not overlap in frequency with resource elements allocated to synchronization signal(s).

The data may comprise an ordered bit sequence and allocating the first portion of the data according to the predetermined allocation scheme may comprise: identifying one or more first sections of the ordered bit sequence that are within the first portion of the data and would map to resource elements of the predetermined set; identifying a corresponding number of second sections of the ordered bit sequence that correspond to the second portion of the data and which map to resource elements outside of the predetermined set; and moving ordered bits of the identified one or more first sections to replace ordered bits of respective second sections.

The method may further comprise, as part of the moving operation, moving the replaced ordered bits of the respective second sections to replace the ordered bits of the identified one or more first sections.

The moving of the ordered bits of the identified one or more first sections may be performed by: determining an offset based at least in part on the bit length N of the first portion of the data sequence; and adding the offset to bit positions of the bits within each identified first section.

The bit sequence may be received from a rate matching buffer after a channel encoder.

The data may comprise an ordered bit sequence and allocating the first portion of the data may comprise mapping a sequence of symbols, generated based on modulating the provided data, to the resource elements of the data channel in increasing order of, firstly, time indices and, secondly, frequency indices, starting from a frequency index offset corresponding to a frequency index outside of the predetermined set.

The frequency index offset may correspond to the first frequency index outside of the predetermined set.

The punctured one or more resource elements may not be transmitted.

The method may comprise performing at least the puncturing responsive to detecting that a narrowband mode of operation is required.

The method may be performed by or at a base station of a radio access network or, alternatively, a user equipment or similar.

According to a fourth aspect, there is described a method, the method comprising: receiving, from a transmitting apparatus, a synchronization signal block of a transmission frame, wherein the synchronization signal block comprises a data channel; extracting data from resource elements of the data channel, wherein the extraction of the data from the resource elements is based on reversing at least part of a predetermined allocation scheme performed by the transmitting apparatus; and decoding the data.

The data channel may comprise a physical broadcast channel (PBCH).

The predetermined allocation scheme may comprise allocating a first portion of the data to resource elements outside of a predetermined set of resource elements which are to be all or partly punctured and at least a second portion of the data, which repeats at least part of the first portion of the data, to resource elements of the predetermined set of resource elements which are to be all or partly punctured.

The extracting of the data from the resource elements may be based on reversing at least the allocation of the first portion of the data to the resource elements outside of the predetermined set of resource elements and the allocation of the second portion of the data to the resource elements of the predetermined set of resource elements.

The predetermined allocation scheme may be a standardized allocation scheme or determined based on receiving from the transmitting apparatus an indication of the predetermined set of resource elements which are to be all or partly punctured.

The method may further comprise: determining that the transmitting apparatus has, or may have applied, the predetermined allocation scheme, wherein the extracting operation is performed responsive to the determination. The determining may be based on one or more of: a synchronization raster point in the received synchronization signal block being indicative that puncturing has been performed according to the predetermined allocation scheme; and a frequency band used for the received synchronization signal block indicative of narrowband operation.

The method may be performed by, or at, a user equipment (UE) or, alternatively, a base station or similar.

According to a fifth aspect, there is provided a computer program product comprising a set of instructions which, when executed on an apparatus, is configured to cause the apparatus to carry out the method of: providing data for transmission on a data channel of a synchronization signal block of a transmission frame; identifying a first portion of the data and a second portion of the data, wherein the second portion of the data repeats at least part of the first portion of the data; identifying a predetermined set of one or more resource elements of the data channel; allocating the data to resource elements of the data channel according to a predetermined allocation scheme, wherein at least part of the first portion of the data is allocated to resource elements outside of the predetermined set and at least part of the second portion of the data is allocated to resource elements of the predetermined set; puncturing at least part of the one or more resource elements of the predetermined set; and transmitting a portion of the data on the data channel using available resource elements for the synchronization signal block after the puncturing.

According to a sixth aspect, there is provided a computer program product comprising a set of instructions which, when executed on an apparatus, is configured to cause the apparatus to carry out the method of: receiving, from a transmitting apparatus, a synchronization signal block of a transmission frame, wherein the synchronization signal block comprises a data channel; extracting data from resource elements of the data channel, wherein the extraction of the data from the resource elements is based on reversing at least part of a predetermined allocation scheme performed by the transmitting apparatus; and decoding the data.

According to a seventh aspect, there is provided a non-transitory computer readable medium comprising program instructions stored thereon for performing a method, comprising: providing data for transmission on a data channel of a synchronization signal block of a transmission frame; identifying a first portion of the data and a second portion of the data, wherein the second portion of the data repeats at least part of the first portion of the data; identifying a predetermined set of one or more resource elements of the data channel; allocating the data to resource elements of the data channel according to a predetermined allocation scheme, wherein at least part of the first portion of the data is allocated to resource elements outside of the predetermined set and at least part of the second portion of the data is allocated to resource elements of the predetermined set; puncturing at least part of the one or more resource elements of the predetermined set; and transmitting a portion of the data on the data channel using available resource elements for the synchronization signal block after the puncturing.

According to an eighth aspect, there is provided a non-transitory computer readable medium comprising program instructions stored thereon for performing a method, comprising: receiving, from a transmitting apparatus, a synchronization signal block of a transmission frame, wherein the synchronization signal block comprises a data channel; extracting data from resource elements of the data channel, wherein the extraction of the data from the resource elements is based on reversing at least part of a predetermined allocation scheme performed by the transmitting apparatus; and decoding the data.

According to a ninth aspect, there is provided an apparatus comprising: at least one processor; and at least one memory including computer program code which, when executed by the at least one processor, causes the apparatus to: provide data for transmission on a data channel of a synchronization signal block of a transmission frame; identify a first portion of the data and a second portion of the data, wherein the second portion of the data repeats at least part of the first portion of the data; identify a predetermined set of one or more resource elements of the data channel; allocate the data to resource elements of the data channel according to a predetermined allocation scheme, wherein at least part of the first portion of the data is allocated to resource elements outside of the predetermined set and at least part of the second portion of the data is allocated to resource elements of the predetermined set; puncture at least part of the one or more resource elements of the predetermined set; and transmit a portion of the data on the data channel using available resource elements for the synchronization signal block after the puncturing.

According to a tenth aspect, there is provided an apparatus comprising: at least one processor; and at least one memory including computer program code which, when executed by the at least one processor, causes the apparatus to: receive, from a transmitting apparatus, a synchronization signal block of a transmission frame, wherein the synchronization signal block comprises a data channel; extract data from resource elements of the data channel, wherein the extraction of the data from the resource elements is based on reversing at least part of a predetermined allocation scheme performed by the transmitting apparatus; and decode the data.

### BRIEF DESCRIPTION OF DRAWINGS

Example embodiments will now be described by way of non-limiting example, with reference to the accompanying drawings, in which:

FIG. 1 illustrates an example of a communication network, according to an example embodiment;

FIG. 2 illustrates an example of a synchronization signal block (SSB);

FIG. 3 illustrates an example of an apparatus configured to practice one or more example embodiments;

FIG. 4 illustrates an example of a physical broadcast channel (PBCH) transport process;

FIG. 5 illustrates part of the FIG. 2 SSB including a predetermined set of resource blocks, according to an example embodiment;

FIG. 6 illustrates part of the FIG. 2 SSB including a different predetermined set of resource blocks, according to an example embodiment;

FIG. 7 is a flow diagram of processing operations for a transmitter, according to an example embodiment;

FIG. 8 illustrates part of the FIG. 2 SSB for indicating an interleaving allocation scheme, according to an example embodiment;

FIG. 9 illustrates part of the FIG. 2 SSB for indicating a mapping allocation scheme, according to an example embodiment; and

FIG. 10 is a flow diagram of processing operations for a receiver, according to an example embodiment.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Example embodiments of the present disclosure may relate generally to the field of wireless communications and wireless communication networks.

Example embodiments of the present disclosure may relate to transmission and reception of narrowband communication signals, for example in cellular communication networks such as, for example, specified by the 3rd Generation Partnership Project (3GPP).

An example suitable system for applying example embodiments is Narrowband 3GPP 5G New Radio (NB NR), which may be for example targeted for supporting future railway communication needs, smart grid operators, and/or public safety applications. For example, the example embodiments may be applied to 3GPP work item with its work item description (WID) drafted for NR support for dedicated spectrum less than 5 MHz. Narrowband NR (NBNR) may be therefore also referred to as “NR support for dedicated spectrum less than 5 MHz”.

For example, the so-called Future Railway Mobile Communication System (FRMCS) in Europe may use NR with 2×5.6 MHz frequency domain duplex (FDD) channels, for example at 874.4-880 MHz and 919.4-925 MHz. Soft migration from the earlier system GSM-R (global system for mobile Communications-railway) requires parallel operation of GSM-R and NR, which may be expected to last approximately ten years (e.g. from 2025 to 2035). Considering the design of GSM-R, approximately 3.6 MHz may be available for NR, depending on the number of parallel GSM-R channels. Simultaneous deployment of NR and GSM-R may include the following: adjacent channel deployment, where the GSM-R and NR signals are allocated non-overlapping adjacent frequency bands; overlay deployment with compact GSM-R channel placement, where GSM-R and NR signal are partially overlapping in frequency and where GSM-R signals are allocated within a relatively narrow bandwidth; overlay deployment with GSM-R channels distributed over the 4 or 5 MHz core band of NR; and overlay deployment with GSM-R channels distributed over the full ER-GSM band.

However, the adjacent channel deployment and the overlay deployment with compact GSM-R channel placement may be preferred since they may enable easier implementation of NR scheduler and have only one boundary between the NR and GSM-R, thereby providing simpler and more predictable coexistence. In addition to the railway scenario, NB NR may be applied for example for smart grid applications, for example with 2×3 MHz FDD channels at 900 MHz frequency range in US, or for public safety applications with 2×3 MHz FDD channels in band 29 for PPDR (public protection and disaster release) in Europe. Further application scenarios may include machine type communication, smart phone communication with special bandwidth scenarios, or the like.

For various reasons, such as for example coexistence with earlier communication systems, it may be desired to transmit signals at a bandwidth that is narrower than intended when designing the signal. One motivation behind this is that, instead of redesigning the signal structure, one goal might be to minimize the changes to the existing implementation. One approach for narrowing bandwidth of a signal is to cut out part of the frequency spectrum of the signal. For example, in the case of orthogonal frequency division multiplexing (OFDM) based systems, this may be implemented by puncturing (e.g. not transmitting or removing before transmission) subcarriers, which may be subcarriers at one or more edge(s) of the OFDM symbols.

Puncturing the signal will however result in loss of information and therefore decoding the signal at a receiver may be harder, or even impossible, and therefore means for mitigating the impact of puncturing are considered in this application.

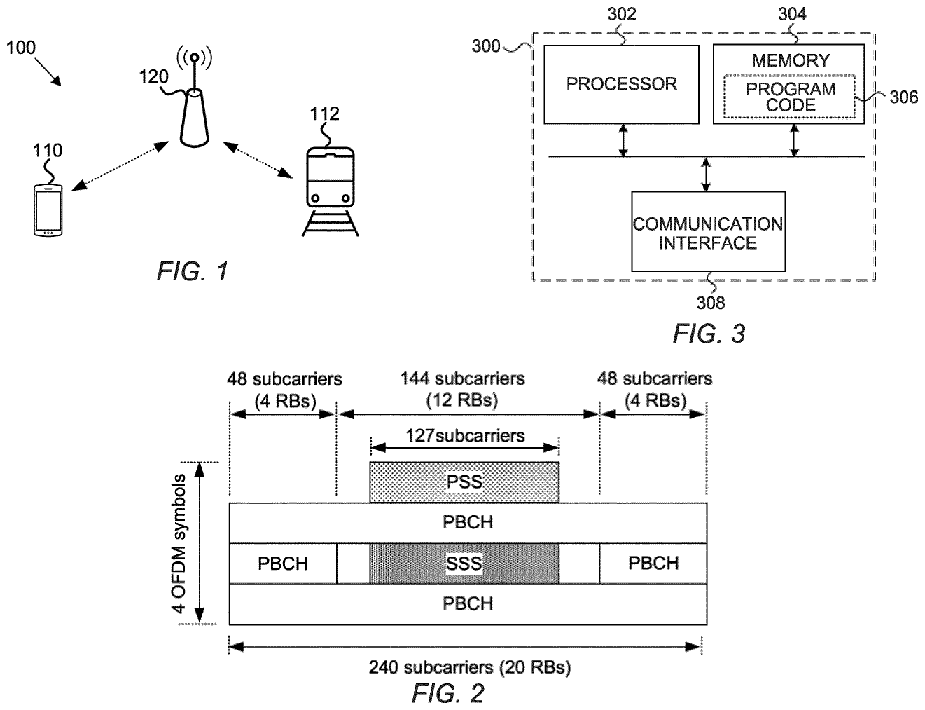

FIG. 1 illustrates an example of a communication network, according to an example embodiment. The communication network 100 may comprise at least one base station 120 and at least one device. A device may be also referred to as a user node, a user device, a client node, or user equipment (UE). A UE 110 may communicate with the base station 120 over wireless radio channel(s). Similarly, a train 112, or a subsystem thereof, may communicate with the base station 120. Communications between the UE 110 (or the train 112) and the base station 120 may be bidirectional. Any of these network nodes may be therefore configured to operate as a transmitter and/or a receiver. Even though some example embodiments have been described using the UE 110 as an example, it is appreciated that similar operations may be performed at various type of devices, such as for example a smart phone, a train equipped with an NR device, a car equipped with an NR device, a subsystem of a smart grid, or the like.

The base station 120 may be configured to communicate with network functions or network devices of a core network to provide communication services for the UE 110. Base stations may be also called radio access network nodes and they may be part of a radio access network (RAN) between the core network and the UE 110. The communication network 100 may be configured for example according to, or based on, NR specifications. The base station 120 may therefore comprise a 5th generation base station (gNB). It is however appreciated that example embodiments presented herein are not limited to devices configured to operate under this example network and the example embodiments may be applied in other type of devices, for example devices configured to operate in any present or future wireless or wired communication networks, or combinations thereof, for example other type of cellular networks, short-range wireless networks, broadcast or multicast networks, or the like. Functionality of the base station 120 may be distributed between a central unit (CU), for example a gNB-CU, and one or more distributed units (DU), for example gNB-DUs. Radio access network elements such as gNB, gNB-CU, or gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

FIG. 2 illustrates an example of a synchronization signal block (SSB) according to an example embodiment. A SSB may comprise symbols, for example OFDM symbols, comprising synchronization signal(s) (SS) targeted for performing synchronization (e.g. time, frequency, and/or frame synchronization) at a receiver, for example the UE 110. A SSB may comprise at least one synchronization signal. The SSB may further carry a data channel. For example a portion of the available subcarriers of the OFDM symbol may be configured for carrying a data channel. Such data channel may comprise any suitable data, for example physical layer signalling information. The physical layer may be configured to handle operations similar to as described in the open systems interconnection (OSI) model or a physical layer specification of a particular standard. An OFDM symbol may comprise a plurality of subcarriers. A modulated subcarrier of an OFDM symbol may be referred to as a resource element (RE). A resource block (RB) may comprise a block of subcarriers, for example a block of twelve consecutive subcarriers or resource elements. An RB may be also referred to as a physical resource block (PRB). A synchronization signal block may comprise a synchronization signal and physical broadcast channel (SS/PBCH) block.

In the example of FIG. 2, the SSB comprises a primary synchronization signal (PSS) and a secondary synchronization signal (SSS). The PSS and SSS may comprise subcarriers modulated with respective sequences of symbols. The SSB may further comprise RBs allocated for a physical layer broadcast channel (PBCH). The SSB may include downlink demodulation reference signals (DM-RS) for PBCH as well as PBCH payload data, for example the master information block (MIB). The MIB may comprise signalling data indicative of system information related to, for example, the frequency position (e.g. SSB frequency domain allocation related to a common resource block (CRB) grid) and timing of the SSB (e.g. half frame timing and frame timing). This signalling information may be contained for example in higher layer payload data (e.g. MIB), as a part of the physical layer bits in the transport block payload, or in DM-RS. PSS and SSS enable downlink frame synchronization and may inform the UE 110 about the physical cell identifier (ID). Downlink transmission may be organized in frames of 10 ms. Based on reception of PSS and SSS, the UE 110 may obtain information about transmission slot timing within the 5 ms half frame. The UE 110 may then determine resource elements for the downlink modulation reference signals (DM-RS) and data to receive the PBCH payload (e.g. MIB).

The PSS may occupy a set of subcarriers of a first OFDM symbol, in this example 127 subcarriers. The PSS subcarriers may be located in the middle of the SSB block in frequency direction. A second OFDM symbol may comprise a set of subcarriers allocated for the PBCH channel. The second OFDM symbols may further comprise DM-RS for PBCH, in this example a set of 240 subcarriers (20 RBs). This set of subcarriers may comprise a continuous set of subcarriers. The set of subcarriers may be partially overlapping in the frequency domain with the set of PSS subcarriers. In general, a set may comprise one or more members of the set.

A third OFDM symbol may comprise the SSS. The SSS may occupy a set of subcarriers of the third OFDM symbol, for example the same subcarriers as the PSS in the first OFDM symbol. At edges of the third OFDM symbol, or in general at one or both sides of the SSS, there may be set(s) of subcarriers (e.g. 48 subcarriers/4 RBs) allocated for the PBCH. The third OFDM symbol may further comprise DM-RS for PBCH. Between the two PBCH blocks of the second OFDM symbol, there may be a set of 144 subcarriers (12 RBs), including the 127 subcarriers of the SSS. Between the SSS and the PBCH block(s), there may be set(s) of unoccupied subcarriers, in this example 17 subcarriers. A fourth OFDM symbol may comprise a set of subcarriers allocated for the PBCH. The fourth OFDM symbol may further comprise DM-RS for PBCH, similar to the second OFDM symbol. The first, second, third, and fourth OFDM symbols may be first, second, third, and fourth OFDM symbols in transmission order. They may be however indexed at any suitable manner, for example from 0 to 3, respectively. With 15 kHz subcarrier spacing, the PSS and SSS may occupy 2.16 MHz from the middle of the band. The PBCH blocks of the second and fourth OFDM symbols may occupy a 3.6 MHz band. Each PBCH block of the third OFDM symbol may occupy a 0.72 MHz band.

Even though a particular structure of the SSB is illustrated in FIG. 2, it is appreciated that the format of the SSB may vary in different implementations. For example, the number and order of the symbols may vary. The example embodiments described herein may be therefore applied to various type of synchronization signal blocks comprising both synchronization signal(s) and one or more data channels. In general, an SSB may comprise symbols, where each of the symbols may comprise resource elements. At least one of the symbols may comprise a synchronization signal on a subset of the resource elements, for example at the middle of the frequency band, as illustrated in FIG. 2.

The symbols may further comprise resource elements of a data channel (e.g. PBCH). In one example embodiment, the SSB may comprise a first OFDM symbol, which may comprise a first synchronization signal (e.g. PSS) on a subset of subcarriers of the SSB. The SSB may further comprise a second OFDM symbol, which may comprise REs of a data channel (e.g. PBCH) at the subcarriers, i.e., not only the subset of subcarrier occupied by the first synchronization signal in the first OFDM symbol. The SSB may further comprise a third ODFM symbol, which may comprise a second synchronization signal (e.g. SSS) on a subset of subcarriers. The subset of subcarriers may be the same subset, which is occupied by the first synchronization signal in the first OFDM symbol. The third OFDM symbol may further comprise REs of the data channel at edge(s) of its subcarriers, e.g. both sides of the second synchronization signal. The SSB may further comprise a fourth OFDM symbol comprising REs of the data channel at its subcarriers. The SSB may be however embodied in various formats, for example comprising any two or more of the first to fourth OFDM symbols, where at least one of the OFDM symbols carries a synchronization signal.

FIG. 3 illustrates an example embodiment of an apparatus 300, for example the base station 120 or the UE 110.

The apparatus 300 may comprise at least one processor 302. The at least one processor 302 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special purpose computer chip, or the like.

The apparatus 300 may further comprise at least one memory 304. The at least one memory 304 may be configured to store, for example, computer program code or the like, for example operating system software and application software. The at least one memory 304 may comprise one or more volatile memory devices, one or more non-volatile memory devices, and/or a combination thereof. For example, the at least one memory 304 may be embodied as magnetic storage devices (such as hard disk drives, floppy disks, magnetic tapes, etc.), optical magnetic storage devices, or semiconductor memories (such as mask ROM, PROM 15 (programmable ROM), EPROM (erasable PROM), flash ROM, RAM (random access memory), etc.).

The apparatus 300 may further comprise a communication interface 308 configured to enable apparatus 300 to transmit and/or receive information to/from other devices. In one example, apparatus 300 may use communication interface 308 to transmit and/or receive signals, control messages, or the like. The communication interface may be configured to provide at least one wireless radio connection, such as for example a 3GPP mobile broadband connection (e.g. 3G, 4G, 5G, 6G). However, the communication interface 308 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 308 may comprise, or be configured to be coupled to, circuitry for performing necessary functions for transmitting and/or receiving signals, for example RF circuitry, modulation circuitry, demodulation circuitry, encoder circuitry, and/or decoder circuitry. The communication interface 308 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

The apparatus 300 may further comprise a user interface (not shown) comprising an input device and/or an output device. The input device may take various forms such a keyboard, a touch screen, or one or more embedded control buttons. The output device may for example comprise a display, a speaker, a vibration motor, or the like. User inputs on the user interface may be configured to cause data transmission and/or reception via the communication interface 310.

When the apparatus 300 is configured to implement some functionality, some component and/or components of the apparatus 300, such as for example the at least one processor 302 and/or the at least one memory 304, may be configured to implement this functionality. Furthermore, when the at least one processor 302 is configured to implement some functionality, this functionality may be implemented using the program code 306 comprised, for example, in the at least one memory 304. Furthermore, a computer program product, a non-transitory computer readable medium, or a machine readable medium comprising (program) instruction may be configured to, when executed, cause performance of the apparatus 300. The functionality described herein may be performed, at least in part, by one or more computer program product components such as software components.

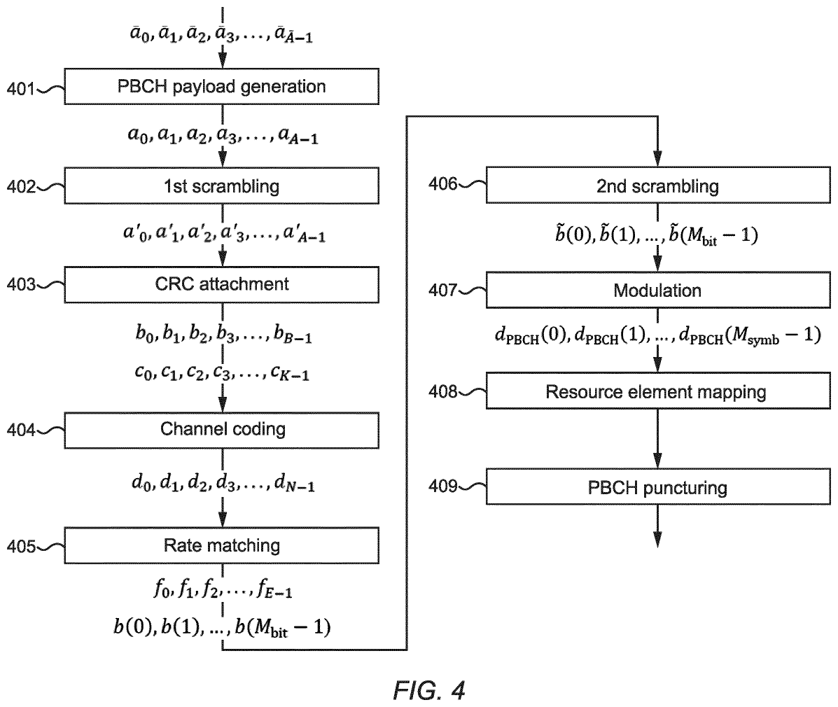

FIG. 4 illustrates an example of a physical broadcast channel (PBCH) transport process. The PBCH transport process may have nine different operations, as illustrated in FIG. 4. However, in some embodiments, all of the operations may not be present. The PBCH transport process may receive as input a set of bits ā₀, ā₁, ā₂, ā₃, . . . ā_{A-1} corresponding to a transport block, where A is the size of payload data of upper transmission layers. The input data may for example comprise 24 bits of BCH (broadcast channel) data.

The PBCH transport process may be carried out by the base station 120. However, a similar process may be in general performed by any apparatus when configured as a transmitter.

Each of the operations illustrated in FIG. 4 will be described in overview.

At an operation 401, the base station 120 may generate the PBCH payload based on the input data. The base station 120 may obtain data for transmission on the PBCH of an SSB of a transmission frame. Even though example embodiments have been described with reference to PBCH, it is understood that the example embodiments may be applied to any type of data channels carried within a synchronization signal block. An example of PBCH payload generation may comprise appending additional timing related to bits to generate PBCH payload bits.

At an operation 402, the appended sequence ā₀, ā₁, ā₂, ā₃, . . . ā_{A-1} may be scrambled to generate a scrambled bit sequence ā′₀, ā′₁, ā′₂, ā′₃, . . . ā′_{A-1}.

At an operation 403, the base station 120 may attach a cyclic redundancy check (CRC) code to the scrambled bit sequence ā′₀, ā′₁, ā′₂, ā′₃, . . . ā′_{A-1}. This may result in a bit sequence b₀, b₁, b₂, b₃, . . . b_{B-1} which may be provided as an input bit sequence c₀, c₁, c₂, c₃, . . . c_{B-1} to a channel encoder.

At an operation 404, the base station 120 may encode the input bit sequence c₀, c₁, c₂, c₃, . . . c_{B-1} using any suitable channel coding method. For example, channel encoding may comprise applying forward error correction (FEC) coding. A channel encoder may add redundant information to the sequence of bits and this may be exploited at the UE 110 for performing error correction. The channel coding may further comprise an interleaving operation, but this may not be applied for the PBCH. The channel coding may be implemented by a polar coder. After the channel coding operation 404 the output bits may be denoted by d₀, d₁, d₂, d₃, . . . d_{N-1} where N is the number of output bits, which may for example equal to 512 which, according to 3GPP TS 38.212 for example, may be written into a circular buffer.

At an operation 405, the base station 120 may perform rate matching. Rate matching may in general comprise adapting the amount of bits to the available transmission resources (PRBs/subcarriers). The output bit sequence after the rate matching operation 405 may be denoted by f₀, f₁, f₂, f₃, . . . f_{E-1}. The length of the rate matching output sequence may be E=864. Where E≥N, as will be the case with the values of N and E mentioned here for the PBCH, it will be noted that there will be bit repetition for f₀, f₁, f₂, f₃, . . . f_{E-1}≥N.

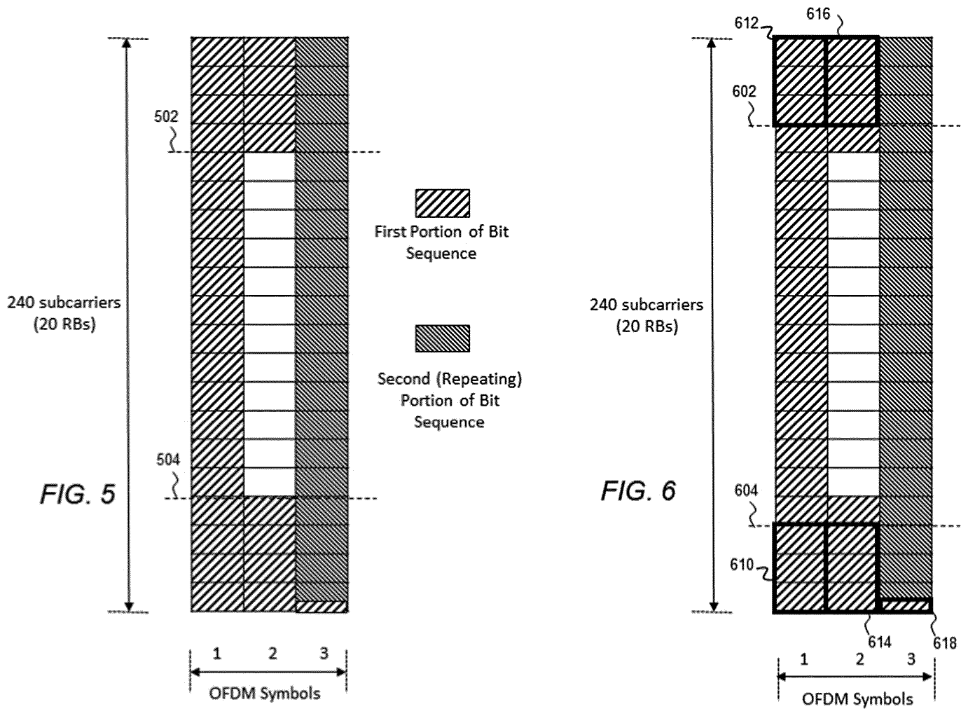

FIG. 5 indicates the bit repetition pictorially when mapped to PBCH RBs of the FIG. 1 SSB. Each RB comprises, in this case, twelve subcarriers or resource elements per OFDM symbol number. For ease of reference, in FIG. 5, the SSB is shown rotated by 90°.

A first portion of the bit sequence f₀, f₁, f₂, f₃, . . . f_{E-1} is shown with first shading and a second, repeating portion of the bit sequence, is shown with second shading. It is worth noting that the repeating bits associated with the 3rd OFDM symbol are allocated almost to the same frequency resources, except for a small shift, as the corresponding bits of the original bit sequence, associated with the 1st OFDM symbol.

Output of the rate matching operation 405 may be provided as an input sequence b(0), b(1), . . . , b(M_{bit-1}) to a second scrambling operation 406 where M_{bit} is the number of bits transmitted on the PBCH.

At an operation 406, the base station 120 may perform a second scrambling operation. Since the second scrambling 406 is located after the channel coding 404, the second scrambling may involve scrambling of channel coded data, which may include redundancy added by the channel coding. By contrast, the first scrambling 402 may involve scrambling of data prior to channel coding. The bit sequence b(0), b(1), . . . , b(M_{bit-1}) may be scrambled to obtain a block of scrambled bits \tilde{b}(0), \tilde{b}(1), . . . , \tilde{b}(M_{bit-1}).

At an operation 407, the base station 120 may modulate the binary sequence \tilde{b}(0), \tilde{b}(1), . . . , \tilde{b}(M_{bit-1}) which may comprise mapping groups of bits of the binary sequence to complex-valued modulation symbols, for example quadrature phase shift keying (QPSK) symbols.

Modulation may therefore result in a complex number sequence d_{PBCH}(0), d_{PBCH}(1), . . . d_{PBCH}(M_{symb-1}).

At an operation 408, the base station 120 may perform resource element (RE) mapping. The RE mapping may comprise mapping the output data (modulation symbols) of the modulation operation 407 to the REs of the PBCH channel.

At an operation 409, the base station 120 may puncture the PBCH channel.

Puncturing the PBCH channel may comprise puncturing (not transmitting) a set of REs (subcarriers), for example at one edge or both edges of the SSB. The punctured REs may comprise REs allocated for the PBCH data. The PBCH data that has been allocated to the REs that are available after the puncturing may be transmitted, while PBCH data that has been allocated to the punctured REs may not be transmitted. A portion of the PBCH data obtained for transmission may be therefore transmitted at the PBCH REs available after the puncturing.

Whilst puncturing may be considered as one solution for reduction of SSB bandwidth, in this case PBCH bandwidth, and is a relatively simple operation to perform, it may have performance impacts.

In this respect, referring again to FIG. 5, a possible puncturing pattern is indicated comprising, for each of the first to third OFDM symbols, four RBs above a first dashed line 502 and four RBs below a second dashed line 504. This puncturing pattern may therefore be termed “symmetric” but this is not essential; asymmetric puncturing patterns and/or different numbers of RBs and/or resource elements “to-be-punctured” may be used as an alternative. Through simulation, it is seen that the effect of puncturing according to this puncturing pattern is not negligible; the Signal to Noise Ratio (SNR) can degrade by as much as roughly 6 dBs.

In view of bit repetition mentioned above, it can be seen that over 50% of bits of the first portion of the coded bit sequence are punctured while over 40% are repeated. This is not optimal and may explain the above performance impacts.

Example embodiments seek to avoid or at least alleviate said performance impacts while reducing SSB bandwidth, for example by using a predetermined allocating scheme for allocating at least part of a first portion of data to be transmitted (e.g. the first portion of the encoded bit sequence shown in FIG. 5) to resource elements which are not to be punctured and at least part of the second portion of data (i.e. e.g. the repeated bits of the encoded bit sequence) to resource elements which are to be punctured, at least partially.

FIG. 6 indicates, similar to FIG. 5, bit repetition pictorially for PBCH RBs/resource elements of the FIG. 1 SSB. A first portion of the bit sequence f₀, f₁, f₂, f₃, . . . f_{E-1} is shown with first shading and a second, repeating portion of the bit sequence, is shown with second shading. An alternative puncturing pattern to that shown in FIG. 5 is indicated. This comprises, for each of the first to third OFDM symbols, three RBs above a first dashed line 602 and three RBs below a second dashed line 604. In other words, six RBs per OFDM symbol. This puncturing pattern is also therefore “symmetric” but this is not essential; asymmetric puncturing patterns and/or different numbers of resource elements “to-be-punctured” may be used as an alternative. The particular puncturing pattern may offer a particularly efficient, possibly optimal puncturing pattern, for transmission of the PBCH as it allows transmission of all bits of the PBCH codeword.

It will be seen that five “sections” 610, 612, 614, 616, 608 of the bit sequence will be punctured according to this particular puncturing pattern and hence by allocating at least some, or all bits, to non-punctured resource elements, performance impacts may be alleviated whilst also achieving the desired low bandwidth operation.

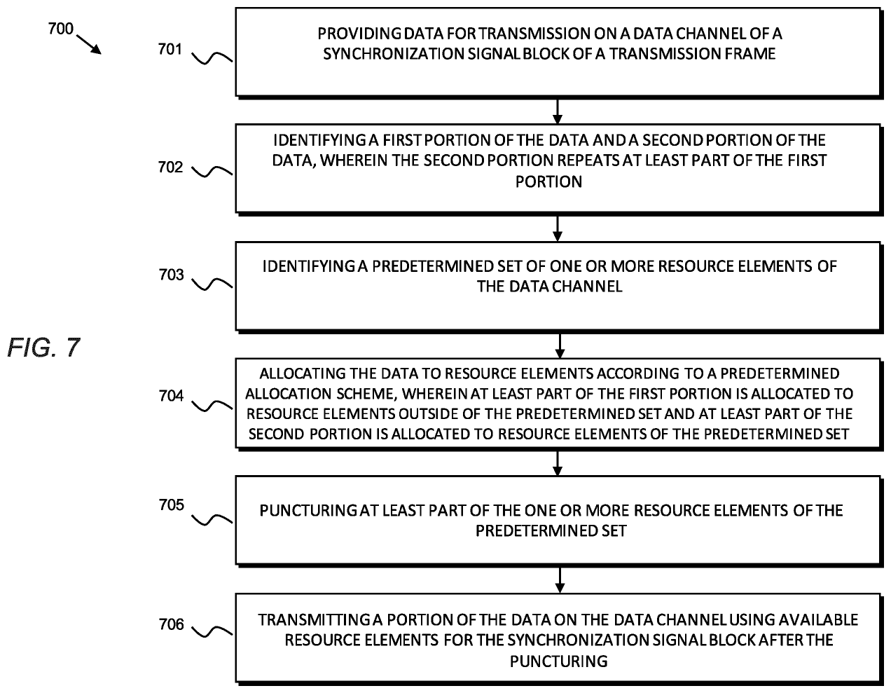

FIG. 7 is a flow diagram showing processing operations, indicated generally by reference numeral 700, according to some example embodiments. The processing operations 700 may be performed in hardware, software, firmware, or a combination thereof. The processing operations 700 may be performed at a transmitter, such as by the base station 120 shown in FIG. 1 or indeed any apparatus or system transmitting data over a data channel.

A first operation 701 may comprise providing data for transmission on a data channel of a SSB of a transmission frame.

A second operation 702 may comprise identifying a first portion of the data and a second portion of the data, wherein the second portion of the data repeats at least part of the first portion of the data.

A third operation 703 may comprise identifying a predetermined set of one or more resource elements of the data channel.

A fourth operation 704 may comprise allocating the data to resource elements of the data channel according to a predetermined allocation scheme, wherein at least part of the first portion of the data is allocated to resource elements outside of the predetermined set and at least part of the second portion of the data is allocated to resource elements of the predetermined set.

A fifth operation 705 may comprise puncturing at least part of the one or more resource elements of the predetermined set. In other words, all resource element(s) of the predetermined set may be punctured, although in other cases, only a subset may be punctured.

A sixth operation 706 may comprise transmitting a portion of the data on the data channel using available resource elements for the SSB after the puncturing.

The data may comprise an ordered bit sequence.

Example embodiments may also provide an apparatus comprising means for performing the processing operations 700. The means may comprise at least one processor and at least one memory directly connected or coupled to the at least one processor. The at least one memory may include computer program code which, when executed by the at least one processor, may perform the processing operations 700 and any preferred features thereof described below.

As noted above, the predetermined set of one or more resource elements may be at at least one edge of the SSB, although this is not necessarily the case. The predetermined set of one or more resource elements may comprise two groups of resource elements at opposite edges of the SSB.

The two groups may or may not be symmetric. Each of the two groups of resource elements may be comprised within four or less RBs per symbol. The data channel may comprises a physical broadcast channel (PBCH) as mentioned above. The predetermined set of one or more resource elements of the PBCH may comprise two groups of resource elements corresponding to symbol numbers 1, 2 and 3, which may or may not be symmetric. The predetermined set of one or more resource elements may not overlap in frequency with resource elements allocated to synchronization signal(s).

At least the fifth, puncturing operation 705 may be performed responsive to detecting that a narrowband mode of operation is required.

According to one example embodiment, the fourth operation 704 may comprise allocating the data to resource elements according to a so-called “interleaving” allocation scheme.

The interleaving allocation scheme may be performed after the rate matching operation 405 described above with reference to FIG. 4 and may be performed at the bit-level, i.e. by acting on the ordered bit sequence from a rate matcher, although is explained herein in terms of the resource elements to which the bits are ultimately mapped.

An interleaving allocation scheme that may form at least part of the fourth operation 405 may, for example, comprise identifying one or more first sections of the ordered bit sequence that are within the first portion of the data and would map to resource elements of the predetermined set. A corresponding number of second sections of the ordered bit sequence may be identified that correspond to the second portion of the data and which map to resource elements outside of the predetermined set. Then, the ordered bits of the identified one or more first sections may replace ordered bits of respective second sections. This may involve swapping the ordered bits of a first section with those of a respective second section.

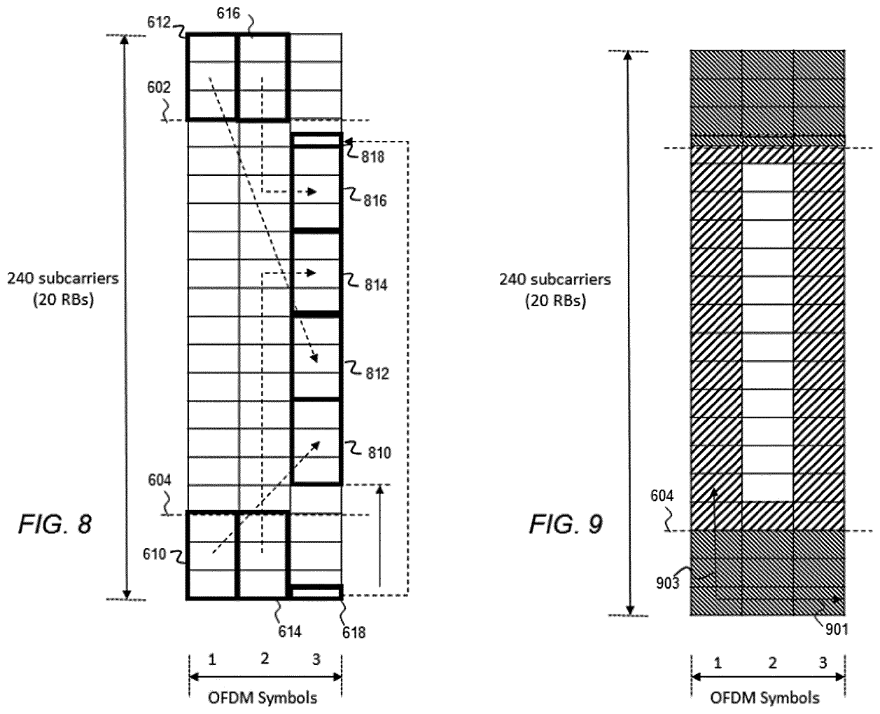

FIG. 8 illustrates pictorially a particular interleaving allocation scheme according to some example embodiments.

FIG. 8 takes the FIG. 6 SSB as its starting point, with five aforementioned first sections 610, 612, 614, 616, 618 of the ordered bit sequence that will be punctured according to the particular puncturing pattern mentioned in relation to FIG. 6. Those resource elements of the three RBs above and the three RBs below the dashed lines 602, 604 respectively represent the predetermined set of resource elements for this puncturing pattern.

In accordance with the example interleaving allocation scheme, the ordered bits of the first to fifth first sections 610, 612, 614, 616, 618 may be swapped with ordered bits of first to fifth second sections 810, 812, 814, 816, 818 as indicated by the dashed arrows. It will be noted that the first to fifth second sections 810, 812, 814, 816, 818 are all outside of the predetermined set of resource elements for this puncturing pattern.

It is evident that by performing the fifth operation 705, the repeated bits within the second portion of the data will be punctured whereas the original bits within the first portion of the data will not be punctured and can be transmitted in the sixth operation 706. This gives an advantage in terms of the total number of original bits transmitted and avoids or at least minimises a loss of information.

Different interleaving allocation schemes may be used, and that described with reference to FIG. 8 is one such example.

The interleaving allocation scheme may be pre-stored at, or is accessible to, the transmitting entity, e.g. the base station 120 shown in FIG. 1. Use of an interleaving allocation scheme is applicable to any spectrum allocation and puncturing scheme, in this particular example allowing transmission of all PBCH codeword bits using symmetric puncturing and equal or lower than three RBs per PBCH edge, corresponding to six punctured RBs per OFDM symbol.

Example pseudo-code for performing the interleaving allocation scheme described above with reference to FIG. 8 is given below.

```
j = 0;
k = 0;
while k < N
  if k < 54 ∥ 306 ≤ k < 414 ∥ k ≥ 450
    v(j) = e(k);
  end
  j = j+1;
  k = k+1;
end while
for i = 0:223
  e(N+64+i) = v(i);
end for
```

where: j is a temporal bit index, k is a coded bit index, Nis the number of output bits (512 for PBCH), 54 is the number of bits within first section 610; 306 is the number of bits within the 17 RBs up to the start of the second section 602; 414 is the number of bits within 23 RBs (across two ODFM symbols) up to the end of third section 614, 450 is the number of bits within 25 RBs (across two ODFM symbols) up to the start of the fourth section 616; and 64 is a starting offset, in terms of number of bits, indicative of where the allocation starts from in the third ODFM symbol outside of a predetermined set.

The offset may be based at least partly on the value of N, plus an additional offset which may allocate bits to the first subcarrier on the fourth RB of the third OFDM symbol containing the PBCH, or to a bit position corresponding to the lowest frequency index outside of a predetermined set on the third OFDM symbol containing the PBCH. This may correspond to the value 64. In this particular example, the additional offset of 64 maps data to the first subcarrier on the fifth RB of the third OFDM symbol containing the PBCH.

According to another example embodiment, the fourth operation 704 may comprise allocating the data to resource elements according to a so-called “mapping” allocation scheme.

The mapping allocation scheme may be performed after the modulation operation 407 described above with reference to FIG. 4. The mapping allocation scheme may be performed at the modulation symbol level.

In this case, and with reference to FIG. 9, example embodiments may map the modulated symbols to resource elements in increasing order of, firstly, time indices l (indicated by arrow 901) and, secondly, frequency indices k (indicated by arrow 903) starting from a frequency index offset k_{offset} corresponding to a frequency index outside of the predetermined set, e.g. above the second dashed line 604.

In some example embodiments, the starting frequency index may correspond to the lowest resource element outside of the predetermined set containing the PBCH in the frequency domain, e.g. using an offset subcarrier which is incremented until it reaches the maximum subcarrier for the PBCH. Then, in modulo fashion, mapping may continue from the lowest subcarrier of the PBCH. The value of the offset subcarrier may be determined based on the predetermined puncturing pattern.

In the context of the PBCH for 5G networks, TS38.211 (5G, NR, physical channels and modulation) may be modified in section 7.4.3.1.3 to include, as indicated below, the wording of the final paragraph, or similar wording, for the case where puncturing is used. The earlier paragraphs relate to the current text in the specification.

“The UE shall assume the sequence of complex-valued symbols d_{PBCH}(0), . . . , d_{PBCH}(M_{symb-1}) constituting the physical broadcast channel to be scaled by a factor β_{PBCH} to conform to the PBCH power allocation specified in [5, TS 38.213] and mapped in sequence starting with d_{PBCH}(0) to resource elements (k,l)_{p,μ} which meet all the following criteria:
they are not used for PBCH demodulation reference signals

The mapping to resource elements (k,l)_{p,μ} not reserved for PBCH DM-RS shall be in increasing order of first the index k and then the index l, where k and l represent the frequency and time indices, respectively, within one SS/PBCH block and are given by Table 7.4.3.1-1.

If PBCH is punctured, the mapping to resource elements ((k+k_{offset}) mod 240, 1)_{p,μ} not reserved for PBCH DM-RS shall be in increasing order of first the index l and then the index k, where k and l represent the frequency and time indices, respectively, within one SS/PBCH block and are given by Table 7.4.3.1-1 and k_{offset} is equal to 36.”

In this case, the value of k_{offset}=3×12=36 may be predetermined, or, as indicated above, the value may be determined as the lowest subcarrier of the PBCH outside the predetermined set, or the value may be determined as the lowest non-punctured subcarrier of the PBCH. Note that, in 38.211 the index k goes through all subcarriers for the PBCH, including those reserved for DMRS, which are skipped over. So, PBCH QPSK symbols are mapped to nine resource elements per twelve resource elements of an RB.

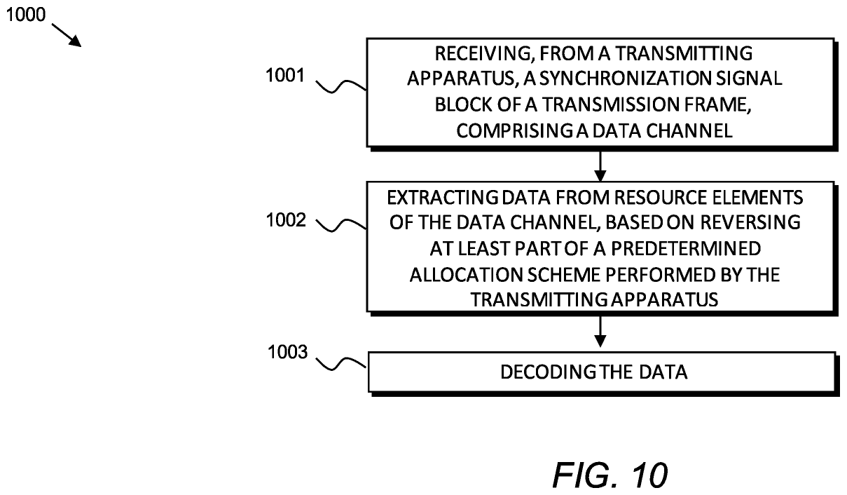

FIG. 10 is a flow diagram showing processing operations, indicated generally by reference numeral 1000, according to some example embodiments. The processing operations 1000 may be performed in hardware, software, firmware, or a combination thereof. The processing operations 1000 may be performed at a receiver, such as by the UE 110 shown in FIG. 1 or indeed any apparatus or system receiving data over a data channel from an apparatus such as the base station 120 shown in FIG. 1.

A first operation 1001 may comprise receiving, from a transmitting apparatus, an SSB of a transmission frame, wherein the SSB comprises a data channel.

A second operation 1002 may comprise extracting data from resource elements of the data channel, wherein the extraction of the data from the resource elements is based on reversing at least part of a predetermined allocation scheme performed by the transmitting apparatus.

A third operation 1003 may comprise decoding the data, i.e. the extracted data.

Some example embodiments may also provide an apparatus comprising means for performing the processing operations 1000. The means may comprise at least one processor and at least one memory directly connected or coupled to the at least one processor. The at least one memory may include computer program code which, when executed by the at least one processor, may perform the processing operations 1000 and any preferred features thereof described below.

The predetermined allocation scheme may be any aforementioned allocation scheme, e.g. the interleaving or mapping allocation schemes.

For example, where the aforementioned interleaving allocation scheme is used, the extracting of the data from the resource elements may be based on reversing at least the allocation of at least part of the first portion of the data to the resource elements outside of the predetermined set of resource elements and the allocation of at least part of the second portion of the data to the resource elements of the predetermined set of resource elements.

Some example embodiments may include an operation of determining the predetermined allocation scheme based on receiving from the transmitting apparatus, e.g. the base station 110 in FIG. 1, an indication of the predetermined set of resource elements. Alternatively, the predetermined allocation scheme may be standardized, e.g. the predetermined set of resource elements and/or how to reverse the allocation scheme at a receiver, may be part of a documented standards specification known by the receiver and hence all the receiver need do is detect that the predetermined allocation scheme has been applied, possibly on a per-transmission basis, and apply the reversal if so. No extra signalling is needed by the transmitter in this case.

Some example embodiments may include an operation of determining that the transmitting apparatus has, or may have applied, the predetermined allocation scheme, and wherein the extracting operation 1002 may be performed responsive to the determination. In other words, the processing operations may involve first determining if puncturing has been performed or may have been performed. The determining in this case may be based on a synchronization raster point in the received SSB being indicative that puncturing has been performed according to the predetermined allocation scheme, and/or a frequency band used for the received synchronization signal block indicative of narrowband operation. For example, if the frequency band in question is known to support only 3 MHz bandwidths, and/or is sometimes used to support 3 MHz bandwidths, then this may trigger the processing operations 1000 described above.

Example embodiments therefore provide a way of achieving narrowband operation using puncturing whilst avoiding or minimising data loss.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1.-25. (canceled)

26. An apparatus, comprising means for performing:
providing data for transmission on a data channel of a synchronization signal block of a transmission frame;
identifying a first portion of the data and a second portion of the data, wherein the second portion of the data repeats at least part of the first portion of the data;
identifying a predetermined set of one or more resource elements of the data channel;
allocating the data to resource elements of the data channel according to a predetermined allocation scheme, wherein at least part of the first portion of the data is allocated to resource elements outside of the predetermined set and at least part of the second portion of the data is allocated to resource elements of the predetermined set;
puncturing at least part of the one or more resource elements of the predetermined set; and
transmitting a portion of the data on the data channel using available resource elements for the synchronization signal block after the puncturing.

27. The apparatus of claim 26, wherein the predetermined set of one or more resource elements are at least one edge of the synchronization signal block.

28. The apparatus of claim 27, wherein the predetermined set of one or more resource elements comprise two groups of resource elements at opposite edges of the synchronization block.

29. The apparatus of claim 28, wherein each of the two groups of resource elements comprise four or less resource blocks per symbol.

30. The apparatus of claim 26, wherein the data channel comprises a physical broadcast channel (PBCH).

31. The apparatus of claim 30 when dependent on claim 3 or claim 4, wherein the predetermined set of one or more resource elements of the physical broadcast channel comprise two groups of resource elements corresponding to symbol numbers 1, 2 and 3.

32. The apparatus of claim 26, wherein the predetermined set of one or more resource elements are not overlapping in frequency with resource elements allocated to synchronization signal(s).

33. The apparatus of claim 26, wherein the data comprises an ordered bit sequence and wherein allocating the first portion of the data according to the predetermined allocation scheme comprises:
identifying one or more first sections of the ordered bit sequence that are within the first portion of the data and would map to resource elements of the predetermined set;
identifying a corresponding number of second sections of the ordered bit sequence that correspond to the second portion of the data and which map to resource elements outside of the predetermined set; and
moving ordered bits of the identified one or more first sections to replace ordered bits of respective second sections.

34. The apparatus of claim 33, further comprising, as part of the moving operation, moving the replaced ordered bits of the respective second sections to replace the ordered bits of the identified one or more first sections.

35. The apparatus of claim 33, wherein the moving of the ordered bits of the identified one or more first sections is performed by:
determining an offset based at least in part on the bit length N of the first portion of the data sequence; and
adding the offset to bit positions of the bits within each identified first section.

36. The apparatus of claim 26, wherein the bit sequence is received from a rate matching buffer after a channel encoder.

37. The apparatus of claim 26, wherein the data comprises an ordered bit sequence and wherein allocating the first portion of the data comprises mapping a sequence of symbols, generated based on modulating the provided data, to the resource elements of the data channel in increasing order of, firstly, time indices and, secondly, frequency indices, starting from a frequency index offset corresponding to a frequency index outside of the predetermined set.

38. The apparatus of claim 37, wherein the frequency index offset corresponds to the first frequency index outside of the predetermined set.

39. The apparatus of claim 26, wherein the apparatus is configured to perform at least the puncturing responsive to detecting that a narrowband mode of operation is required.

40. An apparatus, comprising means for performing:
receiving, from a transmitting apparatus, a synchronization signal block of a transmission frame, wherein the synchronization signal block comprises a data channel;
extracting data from resource elements of the data channel, wherein the extraction of the data from the resource elements is based on reversing at least part of a predetermined allocation scheme performed by the transmitting apparatus; and
decoding the data.

41. The apparatus of claim 40, wherein the predetermined allocation scheme comprises allocating a first portion of the data to resource elements outside of a predetermined set of resource elements which are to be all or partly punctured and at least a second portion of the data, which repeats at least part of the first portion of the data, to resource elements of the predetermined set of resource elements which are to be all or partly punctured.

42. The apparatus of claim 41, wherein the extracting of the data from the resource elements is based on reversing at least the allocation of the first portion of the data to the resource elements outside of the predetermined set of resource elements and the allocation of the second portion of the data to the resource elements of the predetermined set of resource elements.

43. The apparatus of claim 41, wherein the predetermined allocation scheme is a standardized allocation scheme, or is determined based on receiving from the transmitting apparatus an indication of the predetermined set of resource elements which are to be all or partly punctured.

44. The apparatus of claim 41, further comprising means for performing:
determining that the transmitting apparatus has, or may have applied, the predetermined allocation scheme,
wherein the extracting operation is performed responsive to the determination.

45. A method, the method comprising:
providing data for transmission on a data channel of a synchronization signal block of a transmission frame;
identifying a first portion of the data and a second portion of the data, wherein the second portion of the data repeats at least part of the first portion of the data;
identifying a predetermined set of one or more resource elements of the data channel;
allocating the data to resource elements of the data channel according to a predetermined allocation scheme, wherein at least part of the first portion of the data is allocated to resource elements outside of the predetermined set and at least part of the second portion of the data is allocated to resource elements of the predetermined set;
puncturing at least part of the one or more resource elements of the predetermined set; and
transmitting a portion of the data on the data channel using available resource elements for the synchronization signal block after the puncturing.
